(19) United States
(12) Patent Application Publication
(10) Pub. No.: US 2020/0361660 A1
(43) Pub. Date: Nov. 19, 2020

(54) DISPOSABLE BUCKET LINER AND DEODORIZED BUCKET STORAGE SYSTEM

(71) Applicant: Brannon K. Aki, Denver, CO (US)

(72) Inventor: Brannon K. Aki, Denver, CO (US)

(21) Appl. No.: 16/983,211

(22) Filed: Aug. 3, 2020

Related U.S. Application Data
(63) Continuation-in-part of application No. 15/426,740, filed on Feb. 7, 2017.
Application No. 15/426,740 is a division of application No. 14/458,908, filed on Aug. 13, 2014, now Pat. No. 9,598,208.
(60) Provisional application No. 61/866,442, filed on Aug. 15, 2013.

(51) Int. Cl. B65D 25/16; B65D 33/25; B44D 3/12; B65B 3/04; B65B 7/02; B65D 25/32; B65D 33/14; B65D 75/58

(52) U.S. Cl. CPC B65D 25/16; B65D 33/2508; B44D 3/12; B65B 3/04; Y02W 30/80; B65D 25/32; B65D 33/14; B65D 75/5816; B65B 7/02

(57) ABSTRACT

An apparatus and methods of use pertaining to disposable bucket liners for storing solid or liquid content include a flexible bag configured to conform to an interior of a common painting bucket and overlap an open top end of the bucket so as to provide stability for the bag and protection for the bucket. The bag features a reusable closing member that allows the bag to be removed from the bucket and stored to facilitate repeated use before disposal. A deodorizing pet-waste storage system may incorporate the flexible bag or another compostable liner, and includes an oblong receptacle and a deodorizing cover assembly having a press-to-release lid, a carry handle, and an adjustable deodorizing assembly with an odor absorbing filter, thereby enabling indoor storage of pet waste and convenient transport from a storage location to a disposal location for liner removal and disposal. Other embodiments are also disclosed.

### REFERENCE TO PENDING PRIOR PATENT APPLICATIONS

This application is continuation-in-part of pending prior U.S. patent application Ser. No. 15/426,740, filed on Feb. 7, 2017 by Brannon K. Aki for “DISPOSABLE BUCKET LINER,” which application is a divisional of pending prior U.S. patent application Ser. No. 14/458,908, filed on Aug. 13, 2014 by Brannon K. Aki for “DISPOSABLE BUCKET LINER,” issued on Mar. 21, 2017 as U.S. Pat. No. 9,598,208, which application claims the benefit under 35 U.S.C. 119 (e) of U.S. Provisional Patent Application No. 61/866,442, filed Aug. 15, 2013 by Brannon K. Aki for “DISPOSABLE BUCKET LINER,” all of which patent applications are hereby incorporated herein by reference.

### BACKGROUND

Generally, both professional and do-it-yourself painters must spend substantial time cleaning their various tools and containers at the close of a painting session or when switching between paint colors. Such tools and containers may include brushes, rollers, pans, sponges, buckets, and more.

Buckets are particularly difficult to clean in a manner that leaves the bucket free of dried, clumped, and/or crusted paint at the start of the next painting session. Primarily, painting buckets are generally deep five-gallon containers with a great deal of surface area to be cleaned. These size and depth complications are exacerbated when excess paint, which has been wiped from brushes, rollers, and the like, dries into the upper ridges or edges of the bucket. As a result, a painter must either expend valuable time and effort cleaning the internal surfaces and the external ridges of the bucket to render the bucket reusable or dispose of the bucket altogether. For professional painters charging between $35.00 and $50.00 per hour, a half-hour spent cleaning equipment at the end of the day and/or between each color change amounts to a sizeable production loss.

Beyond the time required to clean painting buckets when a painter is stopping for the day, breaking for a period of time, or changing paint colors to continue a job, bucket cleaning requires a great deal of water and an appropriate dump site. Many commercial job sites are not equipped with running water due to staged construction and/or other practical job-site complications. Other job sites don't have appropriate drainage facilities that can accommodate gallons and gallons of paint-tainted water.

Because cleaning a painting bucket between each paint session disposes of the paint coating the bottom, sides, and ridges of the bucket, each cleaning sacrifices a nominal amount of paint. Over time, this amount of washed-away paint adds up to a significant amount of waste.

Disposable bucket liners may provide an alternative to cleaning a paint-coated bucket in preparation for reuse. Using a disposable liner, a painter may complete a job and simply dispose of the liner before replacing it with a new one and continuing on with a new paint color or restarting the project after a break or delay in work. That said, current disposable liners, plastic bags, and/or other disposable receptacles exhibit numerous deficiencies. Generally, liners that are sized and configured to fit the inside of a painting bucket have a height that stops short of the height of the bucket so as not to interfere with the bucket's lid. As a result, the liners don't overlap or fold over the bucket rim, which allows the liners to shift position when paint is poured inside and fails to protect the top rim and the outer ridges encircling the top of the bucket. In addition, existing liners are designed for one-time use and do not feature reusable closure mechanisms that allow for the removal, storage, and later reuse of the paint-filled liners. As a result, they don't allow a painter to quickly and easily store unused paint remaining in the liner during a work stoppage, either for a break, and evening, or while the painter switches between paint colors.

Due to these drawbacks, there is a need for an affordable, disposable mechanism for keeping a paint bucket clean over the course of multiple uses and for allowing paint and painting tools to be stored for easy reuse between painting sessions and color changes.

Substances in addition to paint are oftentimes stored in buckets and/or bags. On the solid spectrum, storage containers, buckets, and/or bags, or a combination thereof, are oftentimes used to store solid pet waste for disposal or between disposals. This type of storage can be unsightly and associated with unpleasant, and even overwhelming, odors in and around the storage container, bucket, or bag. Heat also causes solid pet waste to liquify or partially liquify, rendering the waste nearly impossible to remove in a manner that leaves the storage container or bucket suitable for continued use over time.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

On embodiment provides a disposable liner for a five-gallon bucket having a bottom surface, inner and outer sidewalls, and an open top end. The liner may include a flexible bag having a bottom seam, a top periphery, and a reusable closure member that moves between open and closed positions. When the bag is placed within the bucket and the reusable closure member is placed in the open position, the bottom seam connects with the bottom surface of the bucket and the top periphery folds over the open top end of the bucket such that the reusable closure member abuts the outer sidewall of the bucket.

Another embodiment provides a bucket-and-liner system including a bucket having a bottom surface, inner and outer sidewalls, and an open top end. The system further includes a disposable bag configured to line the bottom surface and the inner sidewall of the bucket. The disposable bag may have flexible walls disposed between a bottom seam and a top periphery and a reusable closure member configured to move between open and closed positions. The flexible walls may be configured to extend across the bottom surface, up the inner sidewall, and over the open top end of the bucket such that the reusable closure member abuts the outer sidewall when the disposable liner is placed within the bucket and the reusable closure member is in the open position.

Yet another embodiment provides a method of applying paint contained within a painting bucket having a bottom surface, inner and outer sidewalls, and an open top end. The method begins with providing a liner system including a disposable bag having flexible walls disposed between a bottom seam and a top periphery and a reusable closure member configured to move between open and closed positions. The method continues with moving the reusable closure member to the open position and placing the disposable bag within the bucket such that the bottom seam connects with the bottom surface of the bucket and the top periphery folds over the open top end of the bucket such that the reusable closure member abuts the outer sidewall of the bucket. Next, the method includes filling the disposable bag with a desired amount of paint, applying the paint to a surface, and, when finished with application of that particular color, moving the reusable closure member to the closed position. Once the disposable bag is closed, the method continues with removing the disposable bag from the bucket for storage outside the bucket. After storage for a desired amount of time, either for a work stoppage or while the user paints in a different color, the method continues with replacing the disposable bag back within the bucket and moving the reusable closure member to the open position.

An additional embodiment provides a method of storing liquid or solid matter contained within a bucket-and-liner system including (a) a five-gallon bucket having a bottom surface, inner and outer sidewalls, and an open top end, and (b) a re-sealable liner sized to fit the bottom surface and inner sidewall of the bucket and extend beyond the open top end of the bucket. The liner may include a reusable closure member configured to move between open and closed positions. The method begins with moving the reusable closure member from the open position to the closed position before removing the re-sealable liner from said bucket.

Still another embodiment provides a deodorizing pet-waste storage system for storing pet waste. The deodorizing pet-waste storage system may include (1) a receptacle, including a base and flat front and rear walls connected by arcuate sidewalls, the flat front and rear walls and the arcuate sidewalls extending proximally-to-distally from the base to a receptacle opening bordered by a utility lip; and (2) a cover assembly, including: (a) a removeable rim forming a lip receiving channel configured to receive and retain the utility lip of the receptacle; (b) a lid rotatively coupled with the removeable rim, wherein the lid arcs between an open lid position and a closed lid position; and (c) a deodorizing assembly including a retainment structure enveloping an odor absorbing filter, wherein the retainment structure is optionally adjustable between an open airflow position enabling an airflow through the retainment structure to the odor absorbing filter and a closed airflow position preventing the airflow through the retainment structure to the odor absorbing filter.

Another embodiment provides a deodorizing cover insert for use with a five-gallon bucket in storing pet waste within the five-gallon bucket, the five-gallon bucket having a base, a circular sidewall, and an open top end. The deodorizing cover insert may include: (1) a removeable rim forming a lip receiving channel configured to receive and retain the open top end of the five-gallon bucket; (2) a lid rotatively coupled with the removeable rim, wherein the lid arcs between an open lid position and a closed lid position; and (3) a deodorizing assembly including a retainment structure enveloping an odor absorbing filter.

A further embodiment provides a method of storing pet waste within a deodorizing storage system including (1) a receptacle having a base, flat front and rear walls connected by arcuate sidewalls extending proximally-to-distally from the base to a receptacle opening, a utility lip bordering the receptacle opening, and a pivoting handle, and (2) a cover assembly having a removeable rim forming a lip receiving channel configured to receive and retain the utility lip of the receptacle, a lid rotatively coupled with the removeable rim, and a deodorizing assembly, the method comprising: (a) removing the cover assembly from the receptacle by separating the lip receiving channel of the removeable rim from the utility lip; (b) disposing a liner within an interior compartment of the receptacle such that an open end of the liner overlaps the utility lip; (c) replacing the cover assembly upon the receptacle such that the open end of the liner is disposed between the utility lip of the receptacle and the lip receiving channel of the removeable rim of the cover assembly; (d) opening the lid; (e) adjusting the deodorizing assembly to an open airflow position enabling odor absorption; (f) disposing an amount of pet waste within the interior compartment of the receptacle; and (g) closing the lid.

Other embodiments are also disclosed.

Additional objects, advantages, and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 provides a front perspective view of one embodiment of a disposable bucket liner;

FIG. 2 provides a front perspective view of a bucket-and-liner system featuring the disposable bucket liner of FIG. 1;

FIG. 3 provides a section view of the bucket-and-liner system of FIG. 2;

FIG. 4 provides another section view of the bucket-and-liner system of FIG. 2;

FIG. 5 provides a front perspective view of another embodiment of a disposable bucket liner held upright by a stability hanger;

FIG. 6 provides a front plan view of another embodiment of a disposable bucket liner;

FIG. 7 provides a flow chart depicting an exemplary method of applying paint to a desired surface;

FIG. 8 provides a flow chart depicting an exemplary method of storing embodiments of the disposable liners of FIGS. 1-6;

FIG. 9 illustrates a top perspective view of one embodiment of a receptacle of a pet-waste storage assembly;

FIG. 10 illustrates a bottom perspective view of the receptacle of FIG. 9;

FIG. 11 illustrates a top perspective view of one embodiment of a utility cover of a pet-waste storage assembly;

FIG. 12 illustrates a bottom perspective view of the utility cover of FIG. 11;

FIG. 13 illustrates a front perspective view of one embodiment of a pet-waste storage assembly including the receptacle of FIGS. 9-10 and the utility cover of FIGS. 11-12;

FIG. 14 illustrates a front perspective view of one embodiment of a deodorizing cover assembly of a pet-waste storage assembly, in a closed lid position;

FIG. 15 illustrates a front perspective view of the deodorizing cover assembly of FIG. 14, in an open lid position;

FIG. 16 illustrates a partial front perspective view of the deodorizing cover assembly of FIGS. 14-15, detailing a deodorizing assembly having a deodorizer cap and an odor absorbing filter removed from the deodorizing assembly;

FIGS. 17A-17B illustrate partial front perspective views of the deodorizing cover assembly of FIG. 16, with the deodorizing assembly in an open airflow position and a closed airflow position, respectively;

FIG. 18 illustrates a front perspective view of another embodiment of a pet-waste storage assembly including the receptacle of FIGS. 9-10 and the deodorizing cover assembly of FIGS. 14-16 and 17A-17B;

FIG. 19 illustrates a front perspective view of the pet-waste storage assembly of FIG. 18, with a bag or liner disposed within the receptacle of the pet-waste storage assembly;

FIGS. 20A-20B illustrate front perspective views of another embodiment of a pet-waste storage assembly including a deodorizing cover insert removed from and installed upon a traditional five-gallon bucket, respectively;

FIG. 21 illustrates a front perspective view of one embodiment of a removeable paint screen for installation within the receptacle of FIGS. 9-10;

FIG. 22 illustrates a rear perspective view of the removeable paint screen of FIG. 21;

FIG. 23 illustrates a front perspective view of the removeable paint screen of FIGS. 21-22, as installed within the receptacle of FIGS. 9-10;

FIG. 24 provides a flowchart depicting an exemplary method of using an embodiment of the pet-waste storage assembly of FIG. 18 for pet waste storage and disposal; and

FIG. 25 provides a flowchart depicting an exemplary method of painting using the removeable paint screen of FIGS. 21-22, as installed within the receptacle of FIGS. 9-10, as shown in FIG. 23.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Various embodiments of the systems and methods described herein relate to the application and storage of paint in a manner that saves time and money and reduces the resources (e.g., water, drainage, excess paint, etc.) traditionally required to complete these tasks. Additional embodiments relate to the storage of solid pet waste such as, for example, dog excrement and soiled cat litter, in a manner that is guarded against undesirable odors, conveniently transportable, affordable, easy to use and empty, and discreet.

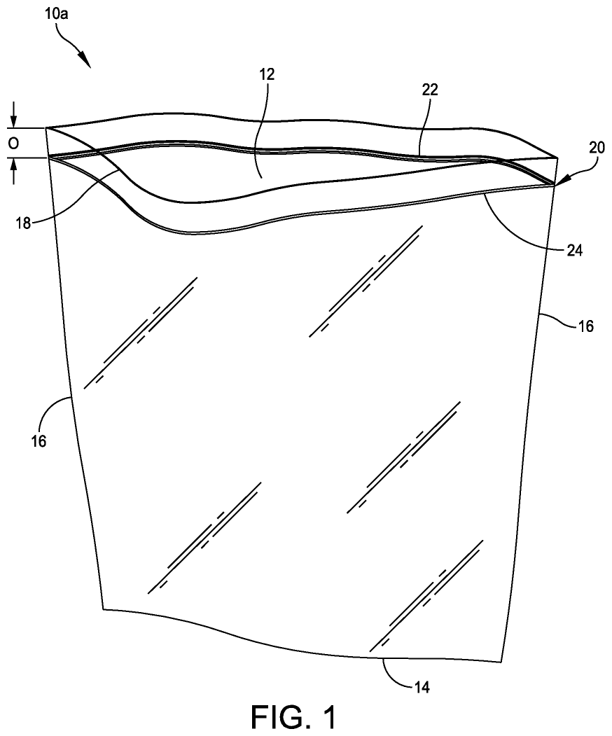

FIG. 1 illustrates a front perspective view of one embodiment of a disposable liner 10ₐ. In this embodiment, liner 10ₐ may be an impermeable, disposable bag having two flexible walls 12 that meet at a bottom seam 14 and identical side seams 16. These bottom and side seams 14, 16 may open to form a top periphery 18. Flexible walls 12 may be formed of any appropriate plastic such as, for example, polyethylene and may have any appropriate thickness. In one embodiment, flexible walls 12 have a thickness between 2 and 4 mil.

To render liner 10ₐ re-sealable, and thus useful for long and/or short-term storage of liquid and/or solid content, a reusable closure member 20 may traverse top periphery 18 at any appropriate offset, o, from top periphery 18. In this embodiment, reusable closure member 20 includes a zip-type lock formed of a grooved track 22 that interlocks via a press-fit with a ridged track 24. Reusable closure member 20 is configured to move repeatedly through open and closed positions via a press fit, thereby allowing a user to access and then store liquid or solid content 34 as many times as necessary until the user has finished with content 34 and is ready to dispose of liner 10ₐ.

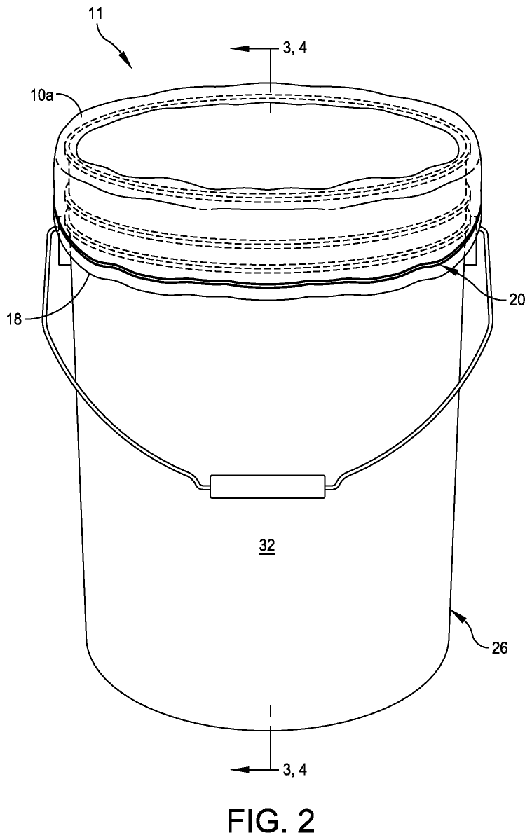

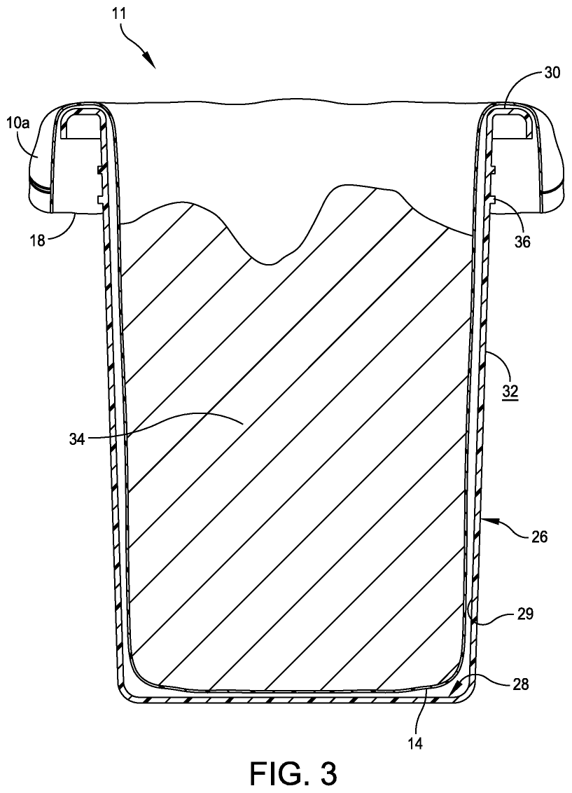

FIGS. 2-4 illustrate perspective and section views of one embodiment of a bucket-and-liner system 11. Specifically, FIGS. 2-3 show liner 10ₐ in an open position and situated within a five-gallon bucket 26, which is a common tool present on construction, remodeling, and other job sites where liner 10ₐ might prove useful. These drawing views illustrate the sizing of liner 10ₐ in relation to bucket 26. Specifically, Liner 10ₐ may be sized such that when placed within bucket 26, bottom seam 14 may contact a bottom surface 28 and an inner sidewall 29 of bucket 26 (FIG. 3). At the same time, top periphery 18 of liner 10ₐ may overlap or fold over an open top end 30 of bucket 26 in a manner that allows reusable closure member 20 to abut an outer sidewall 32 of bucket 26. This overlap allows bucket 26 to perform as a scaffolding of sorts for liner 10ₐ. That is, when content 34 is added to liner 10ₐ, the overlap prevents liner 10ₐ from shifting as liner 10ₐ expands to accommodate content 34 and conform to the inside of bucket 26. This overlap remains as content 34 is added, preventing content 34 from contaminating or interfering with either closure member 20 or any ridges 36 that are present on outer sidewall 32 of bucket 26.

To accommodate a traditional five-gallon painting bucket, each flexible wall 12 of liner 10ₐ may be 21.5 inches long. However, liner 10ₐ may be any appropriate size, shape, length, width, and/or configuration to allow for sufficient overlap when bottom seam 14 of liner 10ₐ contacts bottom surface 28 of bucket 26 and liner 10ₐ expands to conform to inner sidewall 29 of bucket 26. For instance, while FIGS. 1-4 show liner 10ₐ as a flat bag with three distinct seams, it should be understood that liner 10ₐ may take a cylindrical, square, oval, or any other appropriate shape.

With liner 10ₐ in place within bucket 26, content 34, such as, for example, paint may be added to liner 10ₐ and bucket 26 without fear of dripping or smearing excess paint onto inner sidewall 29 or open top end 30 of bucket 26. Further, the overlap protects ridges 36 of outer sidewall 32 when a painter leverages open top end 30 to wipe excess paint from brushes, rollers, sponges, and the like. As a result, when liner 10ₐ is later removed, bucket 26 remains clean and ready for another liner, and thus another paint project or color, or for any appropriate secondary use such as carrying water or storing other equipment (e.g., paint trays, brushes, sponges, etc.).

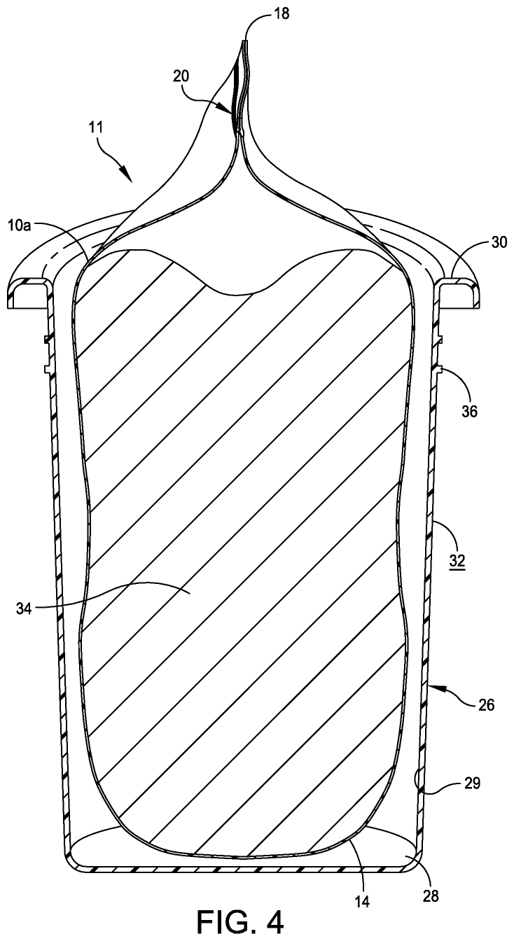

FIG. 4 illustrates a section view of bucket-and-liner system 11, where liner 10ₐ is situated within bucket 26 in a closed position. From this closed position, liner 10ₐ may be lifted from bucket 26 for storage. For instance, a professional painter could remove liner 10ₐ and replace it with another liner before moving to another paint color. Later the painter could return to the original color contained within liner 10ₐ, all by quickly switching liners with no need to spend valuable time cleaning bucket 26 between each color change. Alternatively, the painter might remove liner 10ₐ from bucket 26 to store paint during a break or overnight. In this situation, the painter could store other tools such as brushes and a paint tray within the clean bucket 26.

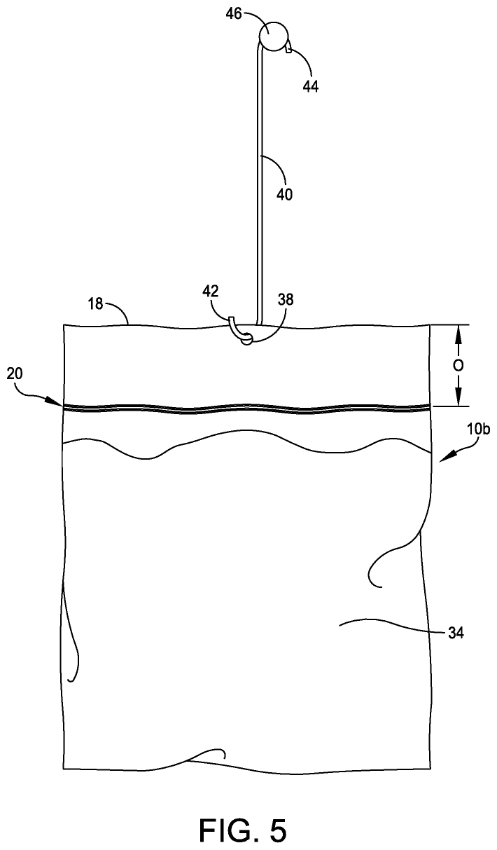

When the liner is removed from bucket 26, it may be beneficial to store it in an upright position so as to keep content 34 away from reusable closing member 20. FIG. 5 illustrates one embodiment of a disposable liner 10_{b} that includes a stability aperture 38 situated between reusable closure member 20 and top periphery 18 of liner 10_{b}. In this embodiment, stability aperture 38 is adapted to engage with a stability hanger 40. One embodiment of stability hanger 40 may include a first hook 42 and a second hook 44. As shown in FIG. 5, first hook 42 may be curved in a manner adapted to engage with stability aperture 38, while second hook 44 may be curved in a manner adapted to engage with a fixed external surface 46, such as a doorknob, shelf edge, or the like. While FIG. 5 shows stability hanger 40 specifically adapted for a doorknob, stability hanger 40 may take any appropriate size, shape, and/or configuration necessary to support liner 10_{b} in an upright position. Further, stability hanger 40 may be formed of any appropriate material such as, for example, metal or plastic. In attrition, while FIG. 5 shows one stability aperture 38, embodiments of liner 10_{b} may include any number of stability apertures 38 necessary to achieve a stable upright resting position.

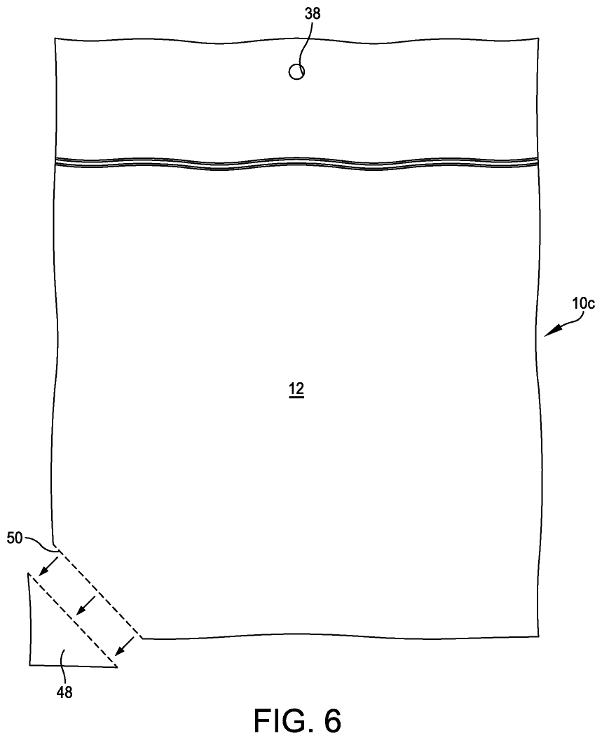

At the close of a project, a user may throw away the disposable liner. In the case of liquid content 34, the user may want to fully empty the liner before disposal. FIG. 6 illustrates a front plan view of one embodiment of a liner 10_{c} Liner 10_{c} may include a tear-away portion 48 that separates from flexible sheets 12 via a perforated line 50. Once the tear-away portion has been removed, the user may squeeze liner 10_{c} to efficiently remove all remaining liquid from the bag before disposal. For example, a user may remove tear-away portion 48 before squeezing all remaining paint within liner 10_{c} back into its original can, thereby minimizing waste.

Embodiments of liner 10_{a-c} allow users to integrate readily available five-gallon buckets into projects that would otherwise require a great deal of clean-up and/or several different buckets to achieve. For instance, rather than using one bucket and cleaning it between each color required of a multi-color paint job, or alternately, employing several painting buckets and cleaning each one at the end of the day or at the end of a work session, a painter may employ one bucket and multiple liners 10_{a-c}. By alternating liners for each color and storing the liners during work stoppages, as discussed above, the painter may maximize his or her painting time and avoid the need for abundant rinse water, drainage outlets, and/or multiple buckets to be juggled and cleaned.

Notably, while liners 10_{a-c} have primarily been discussed with reference to storing paint and its usefulness in the personal and professional painting environment, liners 10_{a-c} and bucket-and-liner system 11, discussed above, may be used with any appropriate solid or liquid content 34. For instance, embodiments of liners 10_{a-c}, may be used to store pet waste or soiled baby diapers between trash-removal days.

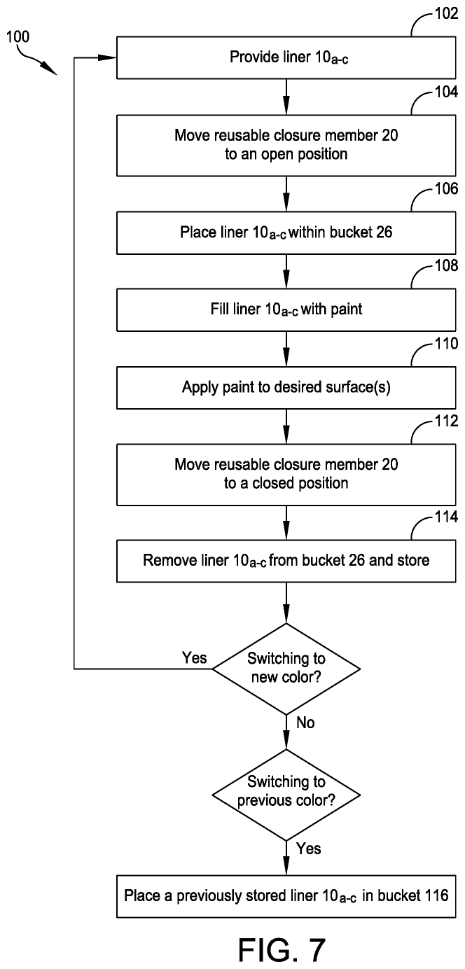

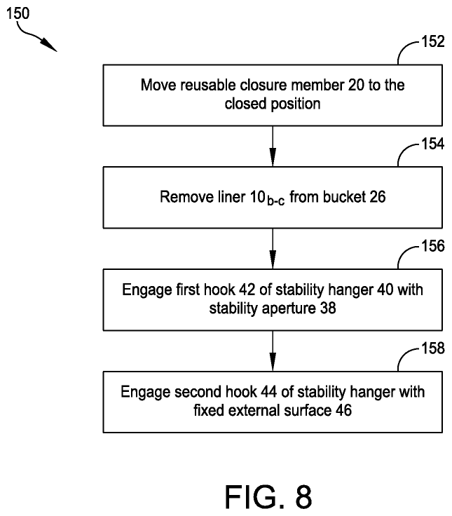

FIG. 7 provides a flow chart depicting an exemplary method 100 for applying paint. Method 100 initiates with the provision of one of liners 10_{a-c} of the type discussed above (102) and continues when a user moves reusable closure member 20 of liner 10_{a-c} to an open position (104). Next, the user may place liner 10_{a-c} within bucket 26 (106) such that bottom seam 14 and top periphery 18 of liner 10_{a-c} connects with bottom surface 28 and folds over open top end 30 of bucket 26, respectively. Once liner 10_{a-c} is in place, the user may fill liner 10_{a-c} (108) with paint and proceed to apply (110) the paint to any surface(s) as desired. When the user is finished with the current paint color, either because he or she is stopping work or wishes to switch colors, the user may unfold top periphery 18 of liner 10_{a-c} and move reusable closure member 20 to the closed position (112) before removing liner 10_{a-c} (114) from bucket 26 for storage outside the bucket according to method 200, discussed below in reference to FIG. 8. If the user is switching to a fresh color, the user may then reinitiate method 100 using a new liner 10_{a-c}. Alternately, the user may place a previously stored liner 10_{a-c} (116) in bucket 26 to effectively toggle between colors without breaking to clean bucket 26.

FIG. 8 provides a flow chart depicting an exemplary method 150 for storing liquid or solid content 34 contained within liner 10_{b-c}. Method 150 initiates when a user moves reusable closure member 20 of liner 10_{b-c} within bucket 26 from the open position to the closed position (152) and removes liner 10_{b-c} from bucket 26 (154). Next, the user may engage first hook 42 of stability hanger 40 with stability aperture 38 of liner 10_{b-c} (156) and engage second hook 44 with fixed external surface 46 (158) to support liner 10_{b-c} in the upright position. Once liner 10_{b-c} has been stored, the user may replace the stored liner with a new liner in bucket 26 or with a liner that had been previously used and stored until needed once more.

While method 150 is discussed in specific relation to liners 10_{b-c}, all liners 10_{a-c} may be stored by simply removing the liners from bucket 26 and setting them aside. Stability aperture 38 and stability hanger 40 simply provide a mechanism for holding liners 10_{b-c} upright in the event that a user desires to keep reusable closure member 20 free and clear of contents 34.

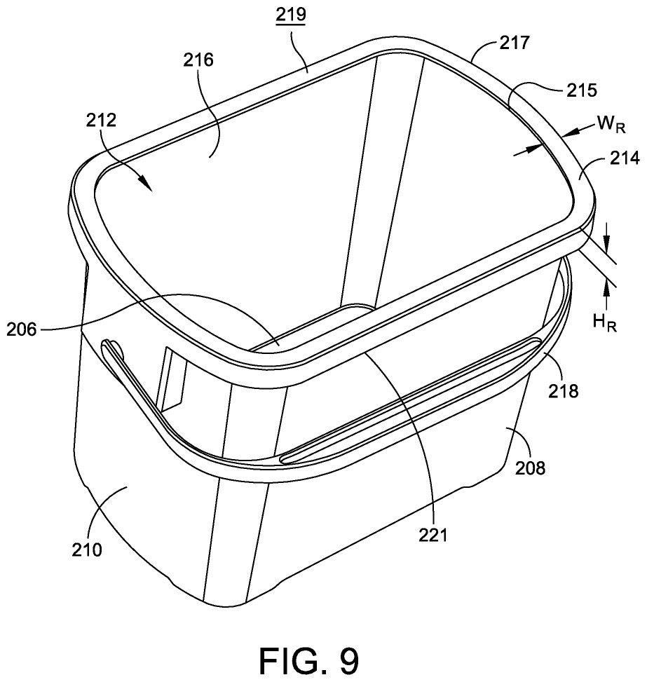

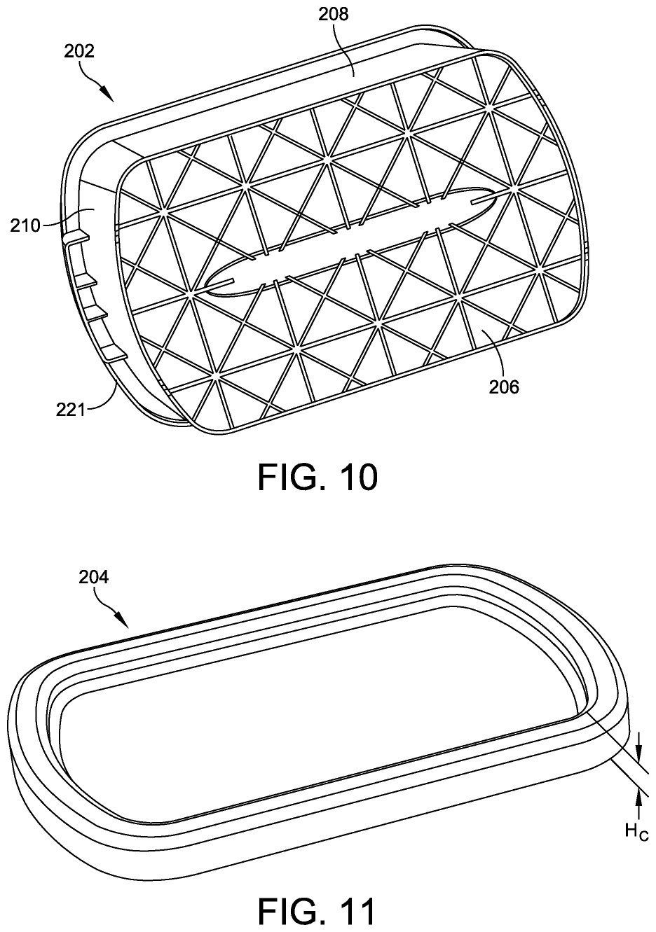

FIGS. 9-20 illustrate embodiments of a pet-waste storage assembly for storing pet waste or other odorous waste products in a manner that is deodorized, transportable, easy to use, easy to empty, affordable, and discreet. Embodiments of the pet-waste storage assembly may also be used for paint storage, in a manner discussed above in relation to FIGS. 1-8.

Turning to exemplary embodiments of the pet-waste storage assembly, FIGS. 9-10 and 11-12 respectively illustrate top and bottom perspective views of one embodiment of a receptacle 202 and top and bottom perspective views of a utility cover 204, which combine to form one embodiment of a pet-waste storage assembly 200ₐ, shown in FIG. 13. In this embodiment, the receptacle 202 may include a base 206 having a pair of flat front and rear walls 208 connected by a pair of arcuate sidewalls 210 extending upward from the base 206. The base 206, the flat front and rear walls 208, and the arcuate sidewalls 210 combine to form an interior compartment 216 adapted to receive contents in the form of pet waste or other odorous waste. In this embodiment, the base 206 and flat and arcuate walls 208, 210 form an oblong or oval-shaped receptacle that more readily fits within confined and/or enclosed spaces such as, for example, against a wall, within a cupboard, or on a shelf.

The flat front and rear walls 208 and the arcuate sidewalls 210 of the receptacle 202 may terminate at a distal end, thereby forming a receptacle opening 212 bordered by a utility lip 214. The utility lip 214 of the receptacle 202 may have a width, W_{R}, extending between an inner edge 215 and an outer edge 217 and a height, H_{R}, extending between a top surface 219 and a bottom edge 221. The width, W_{R}, and the height, H_{R}, of the utility lip 214 may be configured to be received within a mirroring channel of an embodiment of a mating cover, as discussed below in relation to FIGS. 11-12 and 14-16.

In this embodiment, the receptacle 202 may include a carry handle 218 that is rotatively coupled between either the arcuate sidewalls 210, as shown in FIGS. 9 and 13, or the front and rear walls 208, as desired and/or appropriate. The carry handle 218 allows embodiments the pet-waste storage assembly 200ₐ to be conveniently transported between locations such as, for example, between a storage location and a disposal location. For example, soiled cat litter may be placed within the interior compartment 216 of the receptacle 202 while indoors and safely transported out of the house to a disposal bin or dumpster before the receptacle 202 is emptied without risking bag or liner breakage or any other type of spillage.

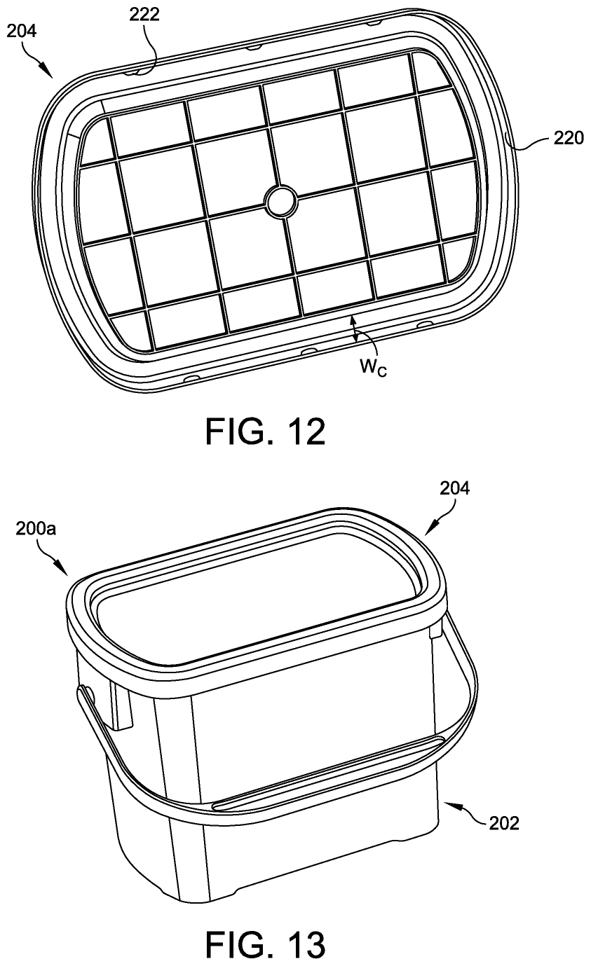

FIGS. 11-12 detail one embodiment of a utility cover 204, which is configured to mate with the utility lip 214 of the receptacle 202 and enclose the interior compartment 216 of the receptacle 202. In this embodiment, the utility cover 204 may form a utility-lip receiving channel 220, as shown in FIG. 12, having a width, W_{C}, and height, H_{C}, configured to receive and retain the utility lip 214 of the receptacle. The receiving channel 220 may also feature a number of flexible snap tabs 222 that extend into the channel 220. The snap tabs 222 may be configured to confront the bottom edge 221 of the utility lip 214 of the receptacle 202 when the cover 202 is placed in a closed lid position over the lip 214 of the receptacle 202, as shown in FIG. 13. To remove the cover, the walls of the receiving channel 220 may be flexed outward to disengage one or more of the snap tabs 222 and release the cover 204 from its engagement with the utility lip 214 of the receptacle 202.

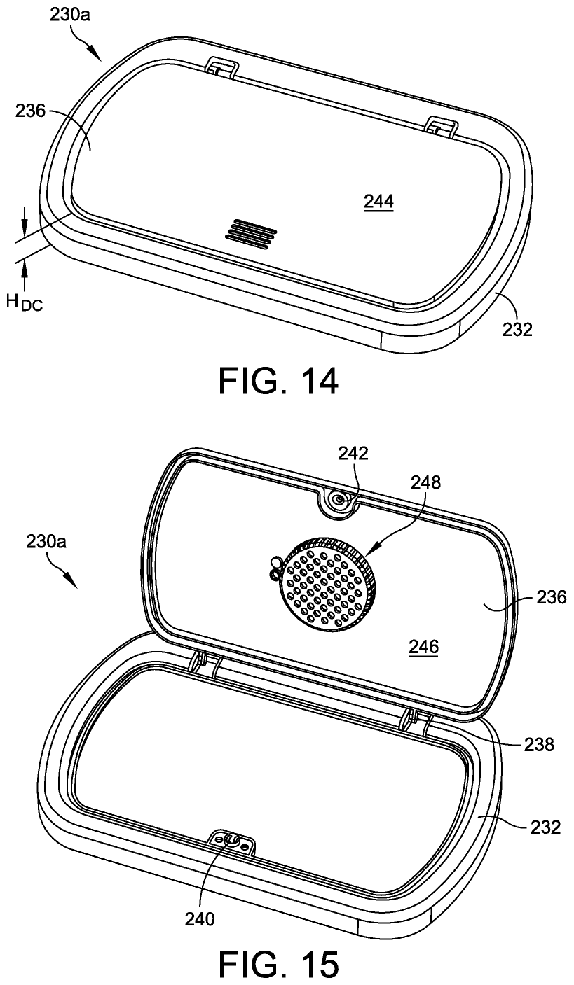

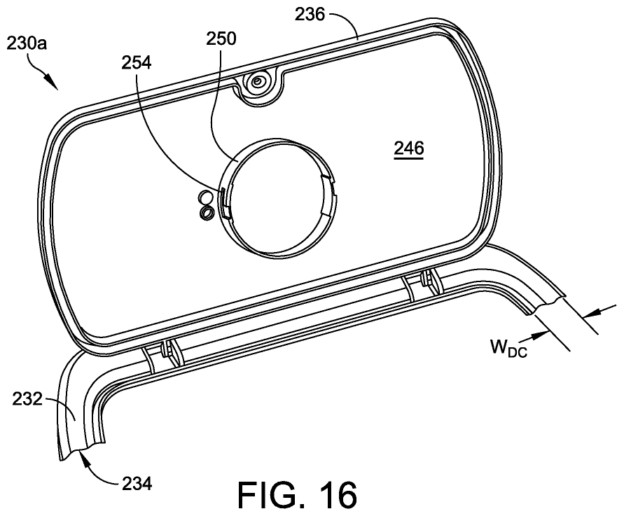

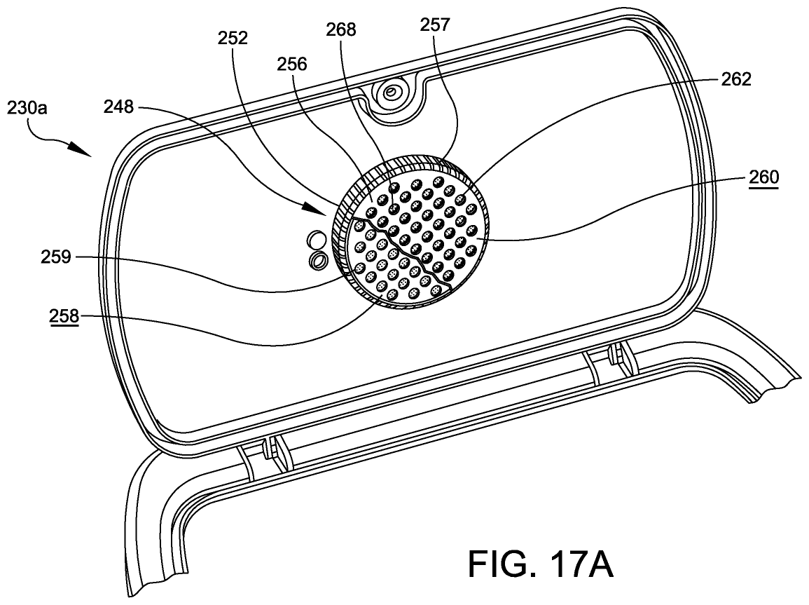

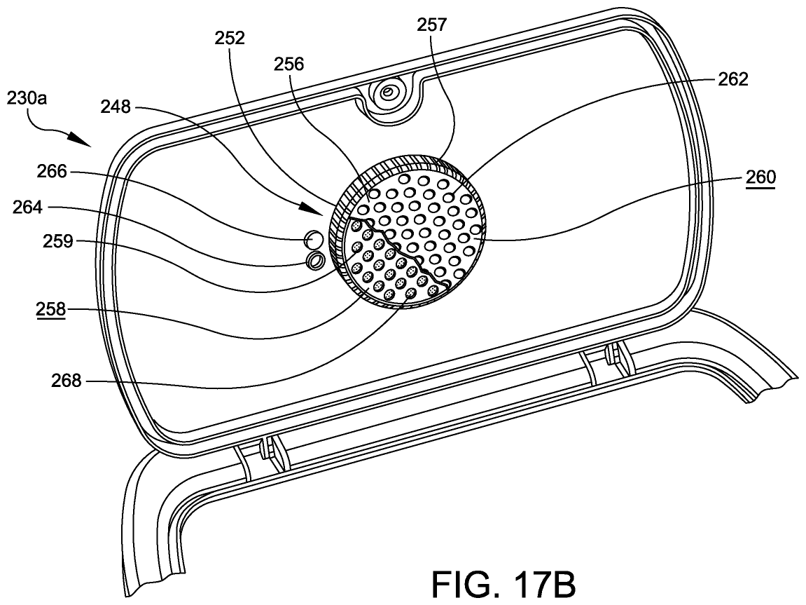

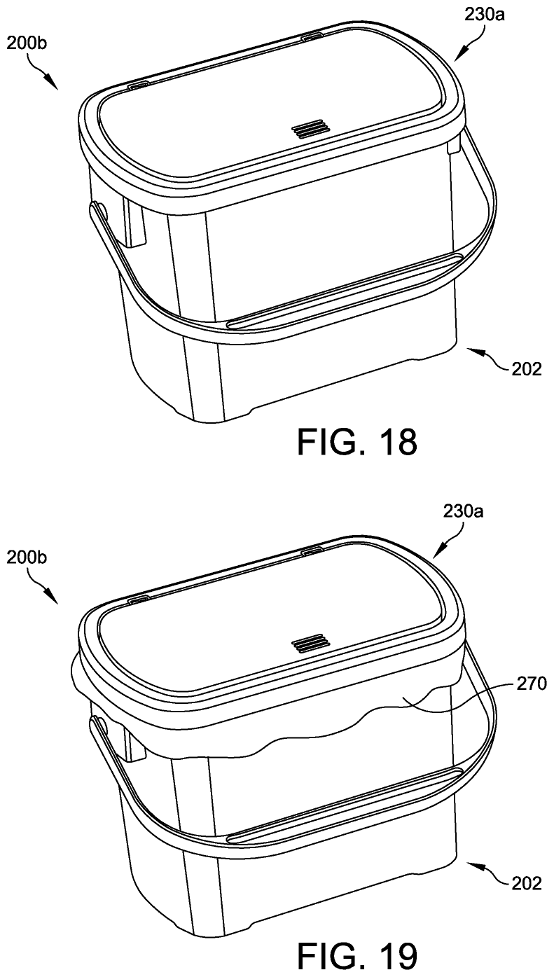

Embodiments of the receptacle 202 may be combined with a variety of different covers or cover assemblies. In this regard, FIGS. 14-15 illustrate perspective views of one embodiment of a deodorizing cover assembly 230ₐ in a closed lid position and an open lid position, respectively, while FIGS. 16 and 17A-17B illustrate perspective partial views detailing a deodorizing assembly of the cover assembly 230ₐ. Embodiments of the deodorizing cover assembly 230ₐ may provide an alternative to the utility cover 204, discussed above in relation to FIGS. 11-12, for use in covering the receptacle 202 to form a pet-waste storage assembly 200_{b}, shown in FIG. 18.

In this embodiment, the deodorizing cover assembly 230ₐ may include a removeable rim 232 that forms a utility-lip receiving channel 234 (FIG. 16) similar to the utility-lip receiving channel 220 of the utility cover 204, discussed above. The utility-lip receiving channel 234 may have a width, W_{DC}, and height, H_{DC}, configured to receive and retain the utility lip 214 of the receptacle 202 and may incorporate the snap tabs (not shown) for holding the cover assembly 230ₐ in place on the utility rim 214 of the receptacle 202.

The deodorizing cover assembly 230ₐ may also include a push-release lid 236 that is rotatively coupled with the removable rim 232 via any appropriate rotative mechanism such as, for example, a pair of hinges 238 or springs that are biased toward an open position of the lid 236, as shown in FIG. 15. A push-to-release latch may be configured to retain the push-release lid 236 in the closed lid position, shown in FIG. 14, and release the lid 236 to the open lid position, shown in FIG. 15, upon the application of a compressive force to a top surface 244 of the lid 236. A similar compression force may be used to return the push-release lid 236 to the closed lid position.

In this embodiment, the push-to-release latch may include a latch portion 240 extending inward from the removeable rim 232 and an opposing catch portion 242 extending outward from a bottom surface 246 of the lid 236 toward the latch portion 240. Embodiments of the push-to-release latch may be mechanical, magnetic, or actuated in any other appropriate manner.

Embodiments of the deodorizing cover assembly 230ₐ may also incorporate a deodorizing assembly 248, detailed in FIGS. 16 and 17A-17B. In this embodiment, the deodorizing assembly 248 may include a retainment structure having an alignment ring 250 extending outward from the bottom surface 246 of the push-release lid 236 and forming an alignment slot 254 therein. As shown in FIGS. 17A-17B, a deodorizer cap 252 may snap into position over the alignment ring 250 such that the cap 252 is disposed about the alignment ring 250 in operable engagement with the alignment slot 254. In this regard, the deodorizer cap 252 may include an adjustable sidewall 257 that engages with the alignment slot 254 of the alignment ring 250 and encircles a dual-layer airflow panel 256, which may include a fixed perforated panel 258 having a fixed perforation pattern 259 layered beneath a rotating perforated panel 260 having a rotating perforation pattern 262.

When the sidewall 257 is manually rotated relative to the alignment slot 254 (FIG. 16), the rotating perforation pattern 262 of the rotating perforated panel 260 rotates into and out of alignment with the fixed perforation pattern 259 of the fixed perforated panel 258, thereby enabling airflow through the aligned perforation patterns 259, 262 into the deodorizing assembly 248 in an open position, shown in FIG. 17A, and preventing airflow through the mis-aligned patterns of the dual-layer airflow panel 256 in a closed position, shown in FIG. 17B. Respective open and closed indicators 264, 266 may provide a visual guide for the user in adjusting the cap 252 between the open and the closed airflow positions of the dual-layer airflow panel 256.

An odor absorbing filter such as, for example, an activated carbon (e.g., activated charcoal) deodorizer filter 268 may be disposed within the boundary formed by the alignment ring 250 and the deodorizer cap 252. In this regard, when in the open position of FIG. 17A, the deodorizing assembly 248 functions to absorb orders within the enclosed pet waste storage assembly 200_{b} of FIG. 18 by exposing the odor absorbing filter 268 to the airflow within the receptacle.

In operation, the deodorizing cover assembly 230ₐ may be removed from the receptacle 202, via the removeable rim 232, before a bag or liner 270 such as, for example, an embodiment of the liner 10_{a-c} discussed above, a proprietary compostable liner, or another commercially-available bag or liner, is placed within the interior compartment 216 of the receptacle 202 such that an open top end of the liner overlaps the utility lip 214 of the receptacle, as shown in FIG. 19. The deodorizing cover assembly 230ₐ may be snapped into place over the liner 270 and the utility lip 214, and the deodorizing assembly 248 may be adjusted to the open position, shown in FIG. 17A, such that odors produced by waste placed within the liner 270 are absorbed by the deodorizing assembly 248.

Embodiments of the pet-waste storage assembly 200_{b} allow for convenient placement of the assembly at a storage location, either indoors or outside, due to effective odor elimination, a streamlined profile, and the carry handle that allows the assembly to be transported without fear of spillage or bag or liner failure. Waste from a pet owner's yard or litter box may be gathered and easily deposited into the receptacle 202 with a downward press upon the push-release lid 236. When trash day arrives, the assembly 200_{b} may be transported from the storage location to a disposal location within close proximity of the user's trash can or dumpster before the liner is removed and dropped into the waste bin. Alternatively, the liner 270 may be removed in place at the storage location and transported to the disposal location.

Embodiments of components of the pet-waste storage assembly 200ₐ, 200_{b}, including the receptacle 202, the utility cover 204, and components of the deodorizing cover assembly 230ₐ, may be formed of any appropriately durable plastic or metal.

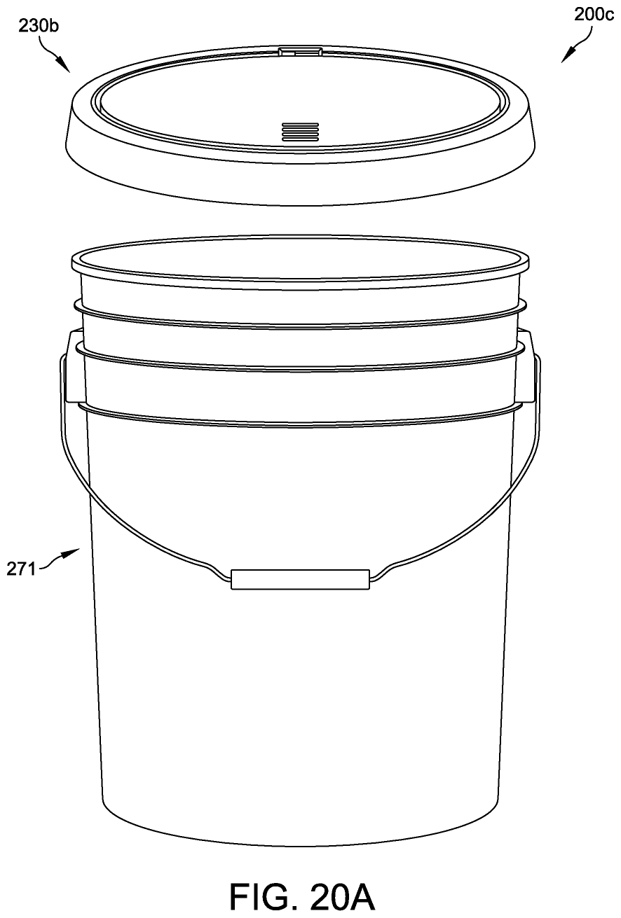

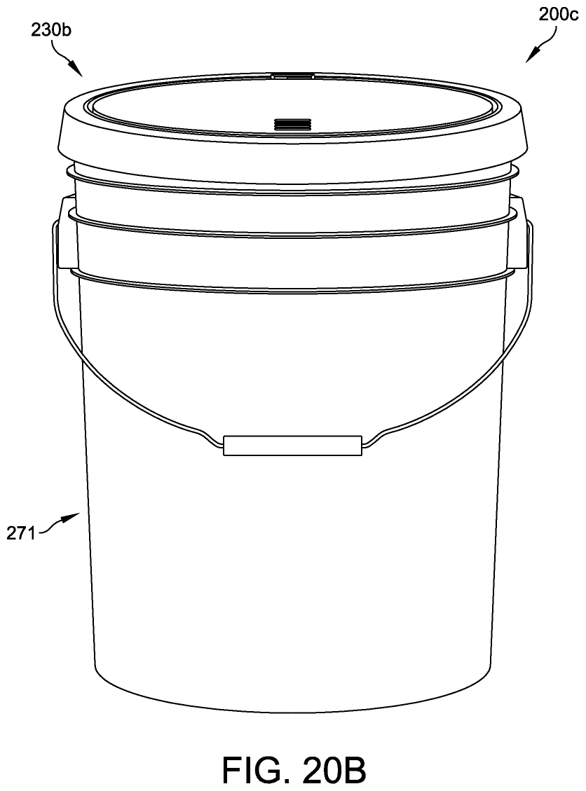

An alternate embodiment of a deodorizing cover assembly 230b may include components identical to the deodorizing cover assembly 230ₐ, discussed above in relation to FIGS. 14-19 (i.e., the removeable rim, deodorizing assembly, push-release lid, push-to-release latch) but be sized for use with a traditional five-gallon bucket 271, rather than with the receptacle 202, as shown in FIGS. 20A-20B. In this embodiment, the deodorizing cover assembly 230b may function as an insert that transforms the traditional five-gallon bucket 271 into a pet-waste storage assembly 200_{c}, providing flexibility and additional cost benefits to the user.

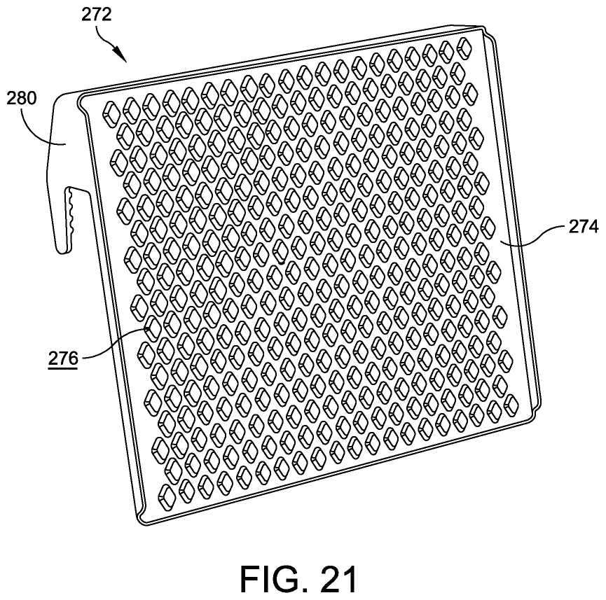

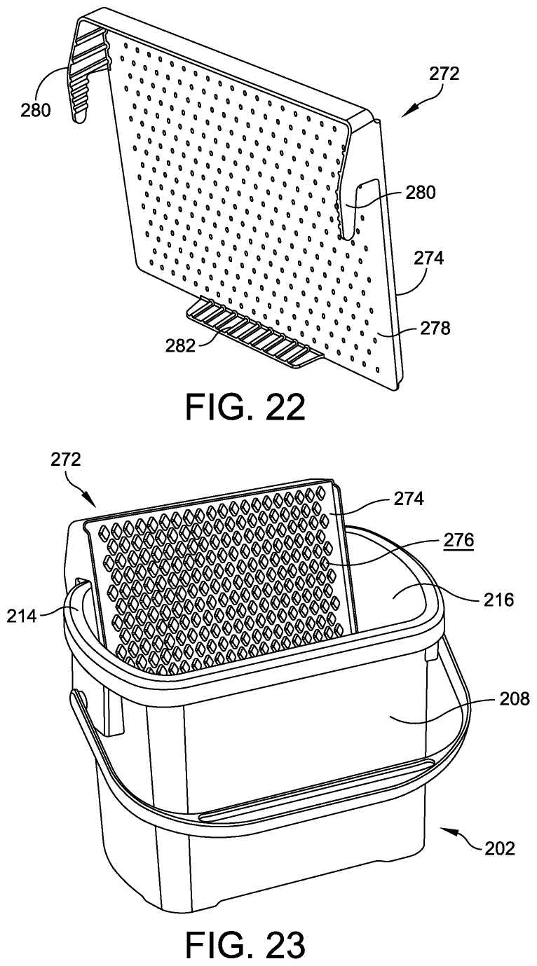

While embodiments of the pet-waste storage assembly 200ₐ, 200_{b} are primarily useful in storing pet waste within or outside the home, one or more accessories may render the receptacle 202 useful for other purposes. In this regard, FIGS. 21-23 illustrate front and rear perspective views of one embodiment of a removeable paint screen 272 for placement within the receptacle 202, as shown in FIG. 23. In this embodiment, the removeable paint screen 272 may include a roller panel 274 having a textured front surface 276 and a rear surface 278. A pair of suspension wings 280 may extend outward from a top portion of the rear surface 278, and an offset panel 282 may extend outward from a bottom portion of the rear surface 278. As shown in FIG. 23, the pair of the suspension wings 280 may be positioned such that they straddle the utility lip 214 along one of the flat walls 208 of the receptacle 202, such that the roller panel 274 extends into the receptacle 202 with the textured front surface 276 facing the interior compartment 216 of the receptacle 202.

Paint may be placed within the receptacle 202, and a paint roller may be dipped into the paint and rolled upon the texturized front surface 276 of the roller panel 274 in preparation for application to paintable surface. In one embodiment, a liner, such as the re-sealable liner 10_{a-c} discussed above in relation to FIGS. 1-6, may be placed within the receptacle 202 prior to installing the removeable paint screen 272 and depositing the paint within the receptacle 202. In this regard, the reusable closure member 20 of the liner may be sealed about the paint screen 272 and the paint contained therein to form a sealed and removable module for storage between painting sessions.

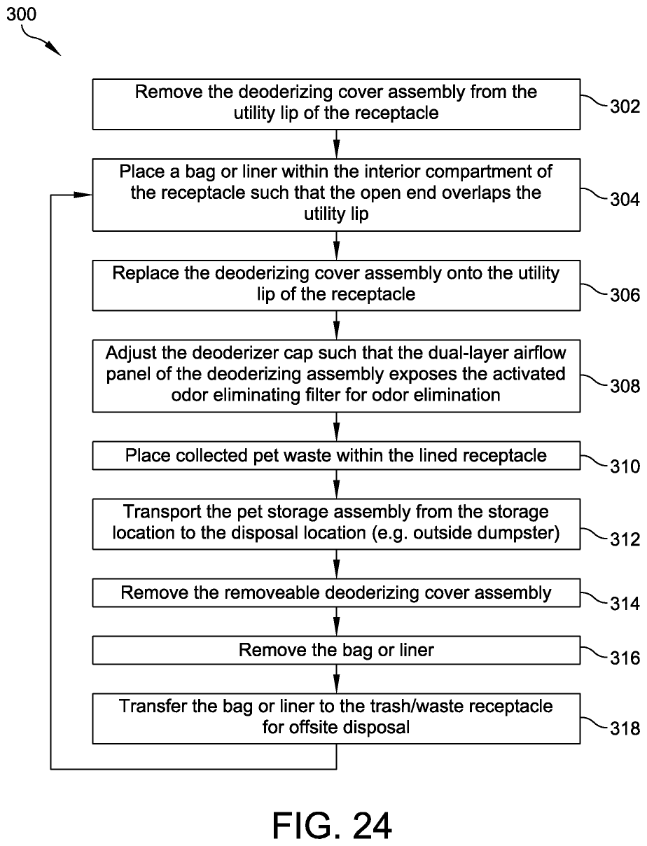

The pet-waste storage systems and accessories described above enable a variety of use methods that provide for convenient, odor-free, discrete, and affordable storage and disposal of pet waste generated outside or within a pet owner's home. FIG. 24 provides a flowchart depicting an exemplary method (300) of using an embodiment of the pet-waste storage assembly 200_{b} for pet waste storage and disposal. The method may initiate with removing the deodorizing cover assembly 230ₐ from the utility lip 214 of the receptacle 202 (302) and placing a bag or liner 270 within the interior compartment 216 of the receptacle 202 (304) such that the open end of the liner 270 overlaps the utility lip 214. In this embodiment, the liner 270 may be any appropriate bag or liner including an embodiment of the liner 10_{a-c} discussed above, a proprietary or commercially-available compostable liner, or a commercially-available waste bag. Once the liner 270 is in place, the user may replace the deodorizing cover assembly 230 such that the lip receiving channel 234 of the removeable rim 232 receives the utility lip 214 of the receptacle 202 (306). The user may also adjust the deodorizer cap 252 such that the dual-layer airflow panel 256 of the deodorizing assembly 248 exposes the odor absorbing filter 268 for odor elimination (308). Over time, collected pet waste—or other odiferous waste, as desired—may be placed within the lined receptacle (310) by pressing the push-release lid 236, passing the waste through the deodorizing cover assembly 230ₐ into the lined receptacle, and closing the push-release lid 236 with another compression of the lid 236.

When the receptacle 202 is full or trash day arrives, the user may easily transport the pet-storage assembly 200_{b} from a storage location (e.g., inside on a shelf, inside a garage) to a disposal location such as, for example, the outside trash receptacle or dumpster using the carry handle 218 (312) before removing the deodorizing cover assembly 230ₐ (314), removing the bag or liner 270 (316), and transferring the bag or line 270 to the waste dumpster or other container (318) at the disposal location for offsite disposal.

The method (300) may equally be carried out using the pet-waste storage assembly 200_{c}, including the pet-deodorizing cover assembly 230b and a traditional five-gallon bucket 271, which replaces the receptacle 202, as discussed above in relation to FIGS. 20A-20B.

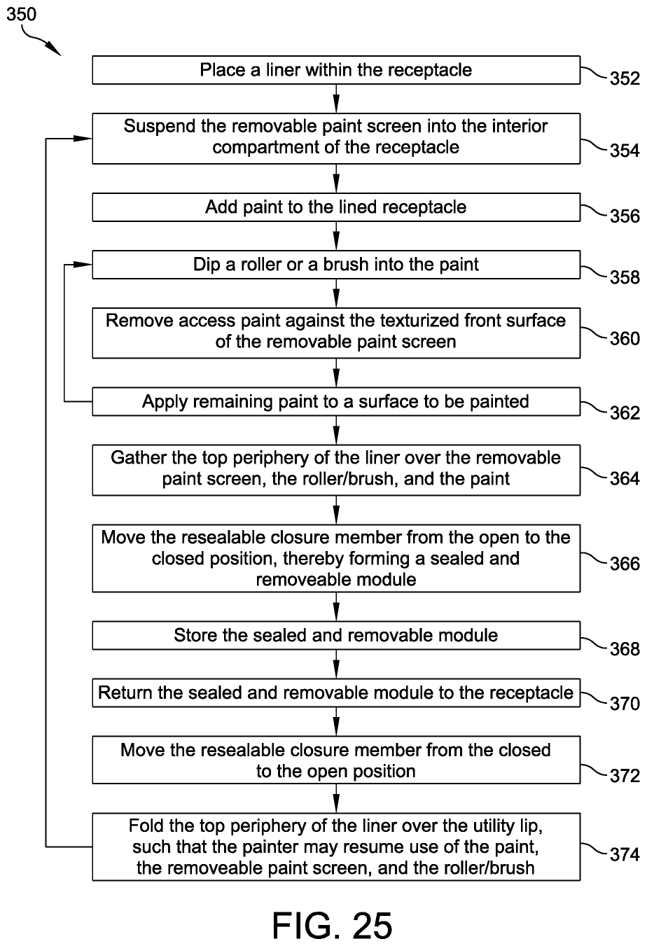

FIG. 25 provides a flowchart depicting an exemplary method (350) of painting using the removeable paint screen 272 suspended within the receptacle 202, as discussed above in relation to FIGS. 21-23. The method (350) may initiate with placing a liner such as, for example, an embodiment of the liner 10_{a-c} discussed above, within the receptacle 202 (352) such that the open end of the liner 10_{a-c} overlaps the utility lip 214 of the receptacle 202. Next, the removeable paint screen 272 may be suspended into the interior compartment 216 of the receptacle 202 (354) by hooking the pair of the suspension wings 280 over the utility lip 214 of the receptacle 202 before paint is added to the lined receptacle 202 (356). Once the removeable paint screen 274 and the paint are within the receptacle 202, the user may dip a paint roller or brush into the paint (358) and remove any excess paint from the roller or brush by rolling or swiping the roller or the brush, respectively, against the textured front surface 276 of the removeable paint screen (360) before applying the remaining paint to a surface to be painted (362).

In one embodiment, and at the close of a painting session, the top periphery 18 of the liner 10_{a-c} may be gathered over the paint, the removeable paint screen, the roller and/or the paint brush, and/or any other tools that have been placed within the lined receptacle (364). The resealable closure member 20 of the liner 10_{a-c} may then be moved from the open position to the closed position, as shown and discussed above in relation to FIGS. 3-4, thereby forming a sealed and removeable module including the liner together with the amount of the paint contained within the re-sealable liner 10_{a-c}, the removeable paint screen 272, and the roller or brush (366). The sealed and removeable module may be stored until a commencement of another painting session (368), allowing the painter to avoid the time and expense of rinsing and cleaning the receptacle 202, the paint screen 272, and the roller or the brush between painting sessions. At the start of a later painting session, the sealed and removeable module may be returned to the receptacle 202 (370), if it was removed, before the resealable closure member 20 is moved from the closed to the open position (372) and the top periphery 18 of the liner 10_{a-c} is folded over the utility lip 214 of the receptacle (374) such that the painter may resume use of the paint, the removeable paint screen 272, and the roller or the brush.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A deodorizing pet-waste storage system for storing pet waste, comprising:
a receptacle, including:
a base; and
flat front and rear walls connected by arcuate sidewalls, the flat front and rear walls and the arcuate sidewalls extending proximally-to-distally from the base to a receptacle opening bordered by a utility lip; and
a cover assembly, including:
a removeable rim forming a lip receiving channel configured to receive and retain the utility lip of the receptacle;
a lid rotatively coupled with the removeable rim, wherein the lid arcs between an open lid position and a closed lid position; and
a deodorizing assembly including a retainment structure enveloping an odor absorbing filter, wherein the retainment structure is optionally adjustable between an open airflow position enabling an airflow through the retainment structure to the odor absorbing filter and a closed airflow position preventing the airflow through the retainment structure to the odor absorbing filter.

2. The deodorizing pet-waste storage system of claim 1, wherein the odor absorbing filter comprises an activated carbon filter.

3. The deodorizing pet-waste storage system of claim 2, wherein the retainment structure comprises:
an alignment ring extending outward from a bottom surface of the lid; and
a deodorizer cap disposed about the alignment ring, the deodorizer cap having a sidewall and a dual-layer airflow panel including a fixed perforated panel forming a fixed perforation pattern and a rotating perforated panel forming a rotating perforation pattern, wherein:
when the rotating perforated panel is adjusted to the open airflow position, the rotating perforation pattern aligns with the fixed perforation pattern; and
when the rotating perforated panel is adjusted to the closed airflow position, the rotating perforation pattern misaligns with the fixed perforation pattern.

4. The deodorizing pet-waste storage system of claim 1, the cover assembly further comprising a push-to-release latch including a latch portion extending inward from the removeable rim and an opposing catch portion extending outward from a bottom surface of the lid toward the latch portion, wherein a compression force upon a top surface of the lid releases the push-to-release latch from the closed lid position to the open lid position.

5. The deodorizing pet-waste storage system of claim 1, the receptacle further comprising a carry handle rotationally coupled between the arcuate sidewalls.

6. The deodorizing pet-waste storage system of claim 1, further comprising a liner disposed within an interior compartment of the receptacle such than an open top end of the liner overlaps the utility lip and is compressed between the utility lip of the receptacle and the removeable rim of the cover assembly.

7. The deodorizing pet-waste storage system of claim 1, wherein the pet waste comprises one or more of an amount of soiled cat litter and an amount of dog excrement.

8. The deodorizing pet-waste storage system of claim 1, further comprising a removeable paint screen for suspension within the receptacle, the removeable paint screen comprising:
a roller panel having a texturized front surface and a rear surface;
a pair of suspension wings extending outward from a top portion of the rear surface of the roller panel, the pair of the suspension wings configured to overlap the utility lip of the receptacle; and
an offset panel extending outward from a bottom portion of the rear surface of the roller panel, the offset panel configured to confront one of the flat front and rear walls such that the roller panel is offset from the one of the flat front and rear walls.

9. A deodorizing cover insert for use with a five-gallon bucket in storing pet waste within the five-gallon bucket, the five-gallon bucket having a base, a circular sidewall, and an open top end, the deodorizing cover insert comprising:
a removeable rim forming a lip receiving channel configured to receive and retain the open top end of the five-gallon bucket;
a lid rotatively coupled with the removeable rim, wherein the lid arcs between an open lid position and a closed lid position; and
a deodorizing assembly including a retainment structure enveloping an odor absorbing filter.

10. The deodorizing cover insert of claim 9, wherein the odor absorbing filter comprises an activated carbon filter.

11. The deodorizing cover insert of claim 9, wherein the retainment structure comprises:
an alignment ring extending outward from a bottom surface of the lid; and
a deodorizer cap disposed about the alignment ring, the deodorizer cap having a sidewall and a dual-layer airflow panel including a fixed perforated panel forming a fixed perforation pattern and a rotating perforated panel forming a rotating perforation pattern, wherein:
when the rotating perforated panel is adjusted to an open airflow position, the rotating perforation pattern aligns with the fixed perforation pattern and enables an airflow through the retainment structure to the odor absorbing filter; and
when the rotating perforated panel is adjusted to a closed airflow position, the rotating perforation pattern is offset from the fixed perforation pattern and blocks the airflow through the retainment structure to the odor absorbing filter.

12. The deodorizing cover insert of claim 9, the cover assembly further comprising a push-to-release latch including a latch portion extending inward from the removeable rim and an opposing catch portion extending outward from a bottom surface of the lid toward the latch portion, wherein when a compression force is applied to a top surface of the lid, the catch portion releases the latch portion.

13. The deodorizing cover insert of claim 9, wherein the pet waste comprises one or more of an amount of soiled cat litter and an amount of dog excrement.

14. A method of storing pet waste within a deodorizing storage system including (a) a receptacle having a base, flat front and rear walls connected by arcuate sidewalls extending proximally-to-distally from the base to a receptacle opening, a utility lip bordering the receptacle opening, and a pivoting handle, and (b) a cover assembly having a removeable rim forming a lip receiving channel configured to receive and retain the utility lip of the receptacle, a lid rotatively coupled with the removeable rim, and a deodorizing assembly, the method comprising:
removing the cover assembly from the receptacle by separating the lip receiving channel of the removeable rim from the utility lip;
disposing a liner within an interior compartment of the receptacle such that an open end of the liner overlaps the utility lip;
replacing the cover assembly upon the receptacle such that the open end of the liner is disposed between the utility lip of the receptacle and the lip receiving channel of the removeable rim of the cover assembly;
opening the lid;
adjusting the deodorizing assembly to an open airflow position enabling odor absorption;
disposing an amount of pet waste within the interior compartment of the receptacle; and
closing the lid.

15. The method of claim 14, wherein:
the cover assembly further comprises a push-to-release latch including a latch portion extending inward from the removeable rim and an opposing catch portion extending outward from a bottom surface of the lid toward the latch portion;
the opening the lid comprises first compressing the lid to release the push-to-release latch; and
the closing the lid comprises second compressing the lid to engage the push-to-release latch.

16. The method of claim 14, wherein:
the deodorizing assembly comprises:
an alignment ring extending proximally-to-distally from a bottom surface of the lid;
a deodorizer cap disposed about the alignment ring, the deodorizer cap having a sidewall coupled with a fixed perforated panel forming a fixed perforation pattern and a rotating perforated panel forming a rotating perforation pattern; and
an odor absorbing filter disposed within a boundary of the alignment ring and the deodorizer cap; and
the adjusting the deodorizing assembly to the open airflow position comprises rotating the rotating perforated panel such that the fixed perforation pattern and the rotating perforation pattern are aligned.

17. The method of claim 16, wherein the odor absorbing filter comprises an activated carbon filter.

18. The method of claim 14, further comprising, after the closing the lid:
transporting, via the pivoting handle, the deodorizing storage system from a storage location to a disposal location.

19. The method of claim 18, wherein the storage location is located inside a building structure and the disposal location is located outside the building structure.

20. The method of claim 18, further comprising, after the transporting and at the disposal location:
removing the cover assembly from the receptacle by separating the lip receiving channel of the removeable rim from the utility lip; and
removing the liner from the receptacle for off-site disposal.
